(19) United States
(12) Patent Application Publication
(10) Pub. No.: US 2025/0365480 A1
(43) Pub. Date: Nov. 27, 2025

(54) SYSTEM AND METHOD FOR DATA CONTROL AND TRANSMISSION

(71) Applicant: Beken Corporation, Shanghai (CN)

(72) Inventors: Long CHEN, Shanghai (CN); Jinyue HUO, Shanghai (CN); Anan XIE, Shanghai (CN); Longbao HU, Shanghai (CN)

(73) Assignee: Beken Corporation, Shanghai (CN)

(21) Appl. No.: 18/764,784

(22) Filed: Jul. 5, 2024

(30) Foreign Application Priority Data
May 21, 2024 (CN) 202410636494.6

(51) Int. Cl. H04N 21/6334; H04N 21/231; H04N 21/239; H04N 21/262

(52) U.S. Cl. CPC H04N 21/6334; H04N 21/23113; H04N 21/2393; H04N 21/26258

(57) ABSTRACT

The present disclosure addresses a system and a method for efficiently transmitting image data from a provider device to one or more receiver devices. The method includes initializing a linked list at a memory of the provider device, mounting a plurality of frames of the data on the initialized linked list, receiving a request from each of the receiver devices to read a frame, determining a next available frame on the linked list for the each receiver device, and transmitting authorization access to the each receiver device, the authorization access granting the each receiver device to read a corresponding next available frame. The method further includes determining that an available storage space of the memory of the provider device is less than a threshold and iteratively remove frames from the linked list until the available storage space of the memory is more than or equal to the threshold.

### CROSS-REFERENCE TO RELATED APPLICATIONS

This application claims priority to and incorporates by reference Chinese application no. 202410636494.6 filed 21 May 2024.

### TECHNICAL FIELD

The present disclosure generally relates to data transmission. In particular, example embodiments of the present disclosure address systems and methods for efficiently transmitting data from a provider to multiple receivers using a linked list.

### BACKGROUND

In the modern era, the exchange of data has become increasingly important across many areas of technology. One major aspect is the transmission of image data between devices and systems. As image sizes continue to increase with higher resolutions, efficiently transmitting image data is critical.

Typically, image data transmission involves a provider device capturing or generating image frames and transmitting them to one or more receiver devices. The receiver devices may need to display, store, or further process the image data. The data transfer must occur quickly and reliably despite resource constraints on systems.

Existing methods for transmitting image data pose several challenges. The large size of image data requires substantial memory and hardware resources for buffering and copying frames. For example, buffering and copying three low-resolution image frames (720p, 30 FPS) for three receiver devices with a compression rate of 30 requires a memory of 720 KB and a copy rate of 5.27 Mbyte/s. This becomes extremely challenging for many systems, especially embedded systems, where memory and hardware resources are highly constrained. Additionally, all receiver devices must operate synchronously at the same frame rate; otherwise, slower receiver devices would constantly miss frames, or the faster receiver devices would have to reduce their output frame rate. This leads to inefficient use of resources and/or reduced performance. Therefore, it is desirable to have a system and a method that can share image data with improved resource usage and transmission performance.

### SUMMARY

In one aspect, a method at a provider device for sharing data from the provider device to one or more receiver devices is provided. The method may include initializing a linked list at a memory of the provider device, mounting a plurality of frames of the data on the initialized linked list, receiving a request from each of the receiver devices to read a frame, determining a next available frame on the linked list for the each receiver device, and transmitting authorization access to the each receiver device, the authorization access granting the each receiver device to read the corresponding next available frame.

In one aspect, a provider device is provided. The provider device may include a processor and a memory. The memory may store instructions for sharing data from the provider device to one or more receiver devices that, when execute by the processor, configure the provider device to initialize a linked list at the memory of the provider device, mount a plurality of frames of the data on the initialized linked list, receive a request from each of the one or more receiver devices to read a frame, determine a next available frame on the linked list for the each receiver device, and transmit authorization access to the each receiver device, the authorization access granting the each receiver device to read the corresponding next available frame.

In one aspect, a non-transitory computer-readable storage medium is provided. The computer-readable storage medium includes instructions that when executed by a provider device, cause the provider device to initialize a linked list at a memory of the provider device, mount a plurality of frames of data on the initialized linked list, receive a request from each of the receiver devices to read a frame, determine a next available frame on the linked list for the each receiver device, and transmit authorization access to the each receiver device, the authorization access granting the each receiver device to read the corresponding next available frame.

### BRIEF DESCRIPTION OF THE DRAWINGS

To easily identify the discussion of any particular element or act, the most significant digit or digits in a reference number refer to the figure number in which that element or act is first introduced.

FIG. 1 is a block diagram illustrating a data transmission system, in accordance with some example embodiments.

FIG. 2 is a schematic diagram illustrating a data flow from the provider to multiple receivers using a linked list structure to control transmission, in accordance with some example embodiments.

FIGS. 3A-3D are schematic diagrams illustrating exemplary frames with status indicators associated with receivers, in accordance with some example embodiments.

FIG. 4 is a table illustrating statuses of mounted frames based on status indicators associated with receivers, in accordance with some example embodiments.

FIG. 5 is a schematic diagram illustrating an exemplary linked list including multiple frames and status indicators, in accordance with some example embodiments.

FIG. 6 is a flowchart illustrating operations of the provider device for transmitting data to multiple receiver devices using a linked list, in accordance with some example embodiments.

FIG. 7 is a flowchart illustrating operations of the provider device for removing mounted frames to save storage space of the memory, in accordance with some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

As mentioned above, current image data transmission methods are inefficient. The substantial buffering and copying required for the large image data size strains limited memory and hardware resources, and the mandatory synchronous receiver operation leads to reduced performance when the frame rates of receivers do not match. Therefore, it is desirable to have a system and a method that can share image data with improved resource usage and transmission performance.

The present disclosure provides systems and methods for efficiently transmitting image data from a provider device to one or more receiver devices without needing to duplicate the data while also managing the provider device's limited memory resources. The systems and methods can be used for transmitting image data in embedded systems. However, it should be noted that other types of data can be efficiently transmitted in other types of systems under the teaching of the present disclosure. Such applications are within the protection scope of the present disclosure. Note that “data transmission” is used interchangeably with “data share” in the present disclosure.

First, a provider device may initialize a linked list data structure in its memory. The initialized linked list may include a plurality of empty slots. The provider device may obtain or generate image frames and mount them onto the plurality of empty slots. The provider device may mount the image frames in orders from one end of the initialized linked list. The older frames (previously mounted frames) may be pushed towards the other end of the list by newer frames (newly mounted frames). The number of empty slots can be preset based on the number of receiver devices. For example, the number of empty slots can be at least one more than the number of receiver devices. In such scenarios, there is at least one frame not being used by any of the receiver devices, and is recyclable for mounting new frames.

After or during mounting the image frames on the linked list, the provider device may receive requests from receiver devices to read the frames. The provider may determine the next available frame on the linked list for each receiver device and transmit authorization access to the each receiver device. The authorization access grants the receiver permission to read the next available frame. Such configuration allows the frames to be read by receivers individually and asynchronously without duplication. Of course, the receivers can also read the frames synchronously and is not limiting herein.

The provider device may track the status of frames as receiver devices read them. When a receiver begins reading a frame, the provider device labels that frame as “in use” in the linked list. Once the receiver device finishes reading the frame, the provider device updates the frame's status to “released.” These status indicators prevent frames still in use from being removed while allowing released frames to be recycled.

The provider device may check periodically if the available storage space of its memory has dropped below a predetermined threshold. If the available space is below the threshold, the provider device starts removing old frames that are no longer in use to recover space. The provider device first looks for a first target group of frames that have been fully read and released by all receiver devices. The provider device may remove the oldest frame (e.g., the frame that is mounted earliest on the linked list or with the smallest frame index) that belongs to the first target group from the linked list. If no frames in the first target group exist or all frames in the first target group have been removed, the provider device looks for frames in a second target group, which are read and released by some of the receivers while unread by others of the receivers. The provider device may remove the oldest frame that belongs to the second target group from the linked list. If no frames in the first target group or the second target group exist, the provider device may look for frames in a third target group, which are unread by the receivers. The provider device may remove the oldest frame that belongs to the third target group from the linked list. The frame-removing operations may be performed iteratively until the available memory space becomes higher than or equal to the predetermined threshold.

By mounting new frames at one end of the list and reading from the other end serially, receivers can get the latest frames efficiently without the provider duplicating frame data. The provider can also intelligently manage its memory by removing old frames based on their tracked status.

The present disclosure potentially has at least the following advantages:
1. Reduces memory and bandwidth usage by eliminating unnecessary data copies and transfers. Frames are shared directly between the provider and receivers without duplication.
2. Improves efficiency of transmission. Receivers can read frames asynchronously at their own frame rates.
3. Saves storage space by recycling unused frames without interfering with the regular operations of receiver devices. Only frames not currently being accessed are recycled.

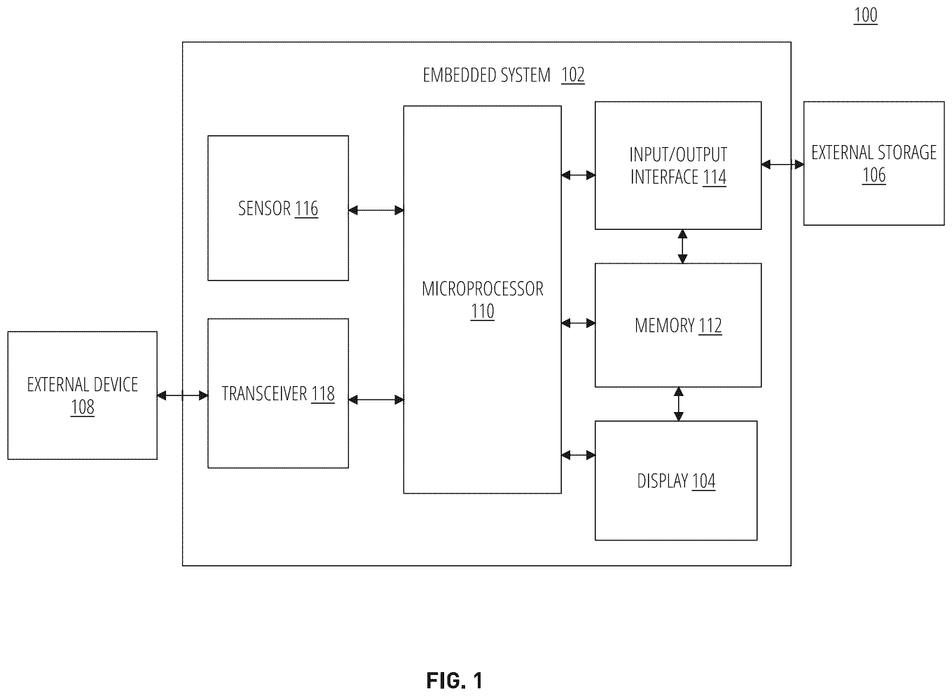

FIG. 1 is a block diagram illustrating a data transmission system 100, in accordance with some example embodiments. The data transmission system 100 may include a provider (e.g., embedded system 102) and one or more receivers (e.g., display 104, external storage 106, external device 108). In the present disclosure, “provider” is used interchangeably with “provider device,” and “receiver” is used interchangeably with “consumer” or “receiver device.”

The embedded system 102 may include a processor 110, a memory 112, an input/output interface 114, a sensor 116, a transceiver 118, and/or a display 104. In some examples, the embedded system 102 may be connected with an external storage 106 via the input/output interface 114. In some examples, the embedded system 102 may be connected with an external device 108 via the transceiver 118. It should be noted that the embedded system 102 is for illustrative purposes and shall not be limiting. Components in the embedded system 102 may be combined, altered, or omitted. Extra components can be included in the embedded system 102. It should also be noted that the present disclosure can be employed by other types of systems, such as tablets, cell phones, computers, servers, etc. Such applications are also within the protection scope of the present disclosure. The microprocessor 110 executes instructions and processes data for

the operations of the embedded system 102. The microprocessor 110 may be responsible for executing processes related to efficient image data transmission as described in the present disclosure, including initializing a linked list data structure in the memory 112, mounting image frames onto the linked list, granting authorized access to receiver devices to read the frames, tracking frame access status, managing memory by removing old frames, etc.

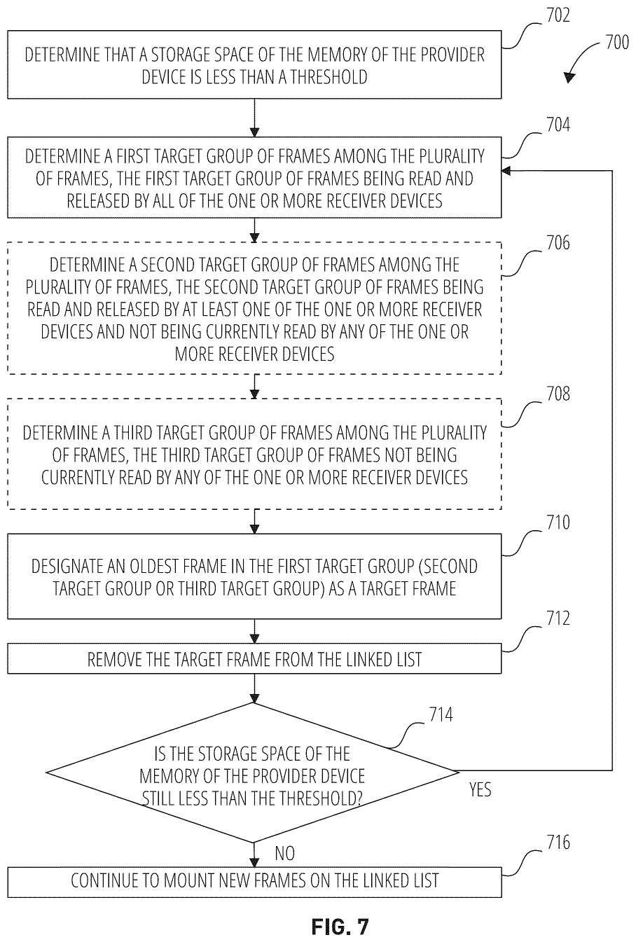

The memory 112 may store a linked list used for mounting image frames in an ordered fashion. Frames are added by the provider device to one end of the list while receivers access the frames from the other end. The memory 112 may contain status indicators tracking which receiver devices are currently accessing each frame. The memory 112 may statically pre-assign a storage space for the linked list based on expected storage needs. Alternatively, the storage space can be dynamically allocated during operation based on actual usage. Static memory allocation is less flexible but would not create any memory fragmentations. Dynamic memory allocation is more flexible and robust but may create memory fragmentations. The memory 112 may intelligently manage its storage space by removing old frames from the linked list. Details regarding how the frames can be removed from the linked list can be found elsewhere in the present disclosure (e.g., FIG. 7).

The input/output interface 114 enables connectivity and data transfer between the embedded system 102 and attached external storage, such as the external storage 106. The input/output interface 114 may support interfaces like USB, Firewire, Thunderbolt, Ethernet, RS-232, SDIO, etc. The input/output interface 114 may coordinate the timing and transfer of data.

The sensor 116 allows the embedded system 102 to collect input from physical camera sensors that capture image data. Example image data formats generated by the camera sensors include YUV, JPEG, and RGB formats but are not limiting. The camera sensors may utilize technologies like Complementary Metal-Oxide Semiconductor (CMOS), Charge-Coupled Device (CCD), or active pixel sensors to convert light into digital images. The captured image data from sensors can then be processed, stored, displayed, or transmitted to other components in the embedded system 102.

The transceiver 118 enables wireless transmission and reception of data signals between the embedded system 102 and external devices (e.g., external device 108) using wireless protocols, such as Wi-Fi, Bluetooth, Zigbee, etc. The transceiver 118 may contain both a transmitter and a receiver with components like oscillators, amplifiers, filters, and modulators/demodulators (modems) for sending and receiving signals. The transceiver also allows transmission of authorization access, granting receiver devices permission to read image data frames mounted on a linked list of the memory 112. This access control provides coordinated sharing of frames between the embedded system 102 and external receivers.

The display 104, the external storage 106, and the external device 108 are three example receiver devices that can obtain shared image data frames from the embedded system 102. The display 104 can be an internal component of the embedded system 102 or an external component connected with the embedded system 102 via the input/output interface 114. The display 104 allows visual output in formats of images, video, graphics, text, etc. The display 104 may have different frame refresh rates from the embedded system 102 and other receivers, and may read available frames from the shared linked list in the memory 112 synchronously or asynchronously.

The external storage 106 can be any persistent memory storage device connected via the input/output interface 114. Example devices include hard disk drives, solid state drives, SD cards, flash storage chips, etc. The external storage 106 may store image data frames from the embedded system 102 for later retrieval and analysis. The external storage 106 may query (send an access request) and read available frames from the shared linked list of the memory 112. The external storage 106 may enable offline processing of captured image data.

The external device 108 represents any auxiliary devices wirelessly connected with the embedded system 102 via the transceiver 118, using protocols like Wi-Fi, Bluetooth, or Zigbee. The external device 108 may alternatively connect with the embedded system via the input/output interface 114. The external devices may require image data from the embedded system for transmission, additional processing, or display. For example, an external router may relay frames over the internet to a mobile device. As another example, a companion chip may analyze images with AI algorithms before sending results back to the embedded system 102. Like other receivers, the external device 108 can obtain shared frames on demand from the linked list in the memory 112.

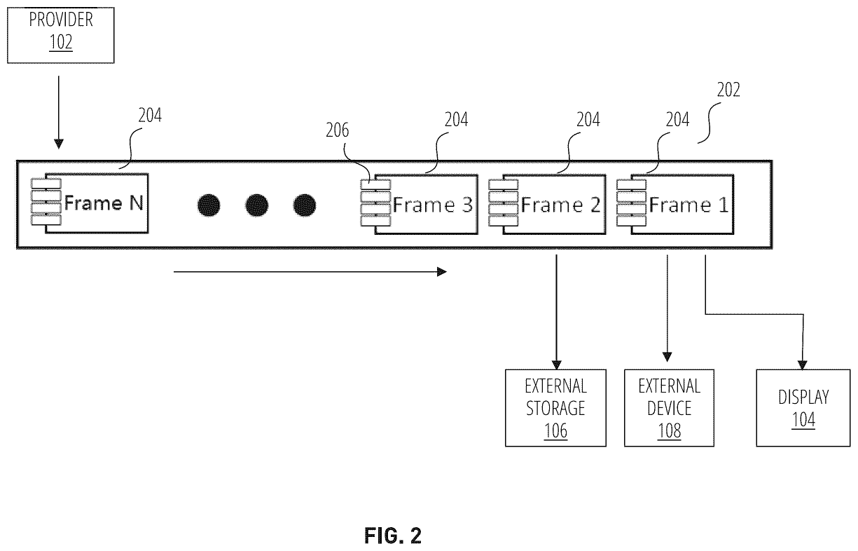

FIG. 2 is a schematic diagram illustrating a data flow from the provider (e.g., embedded system 102) to multiple receivers (e.g., external storage 106, external device 108, display 104) using a linked list structure 202 to control transmission, in accordance with some example embodiments.

The linked list 202 contains a plurality of slots that can each hold a frame of data. The embedded system 102 sequentially mounts new frames of data onto one end (e.g., left end) of the linked list 202 over time. As new frames (frames with larger index) are mounted, earlier frames (frames with smaller index) already on the list are pushed towards another end (e.g., right end) of the linked list 202. This creates an ordered sequence where the newest frames are on the left end, and the oldest frames progress towards the right end as the list grows. Frame age and order along the linked list 202 can be used to manage frames 204 when allocating storage resources.

Receivers such as external storage 106, external device 108, and display 104 can access frames 204 mounted on the linked list 202 by the embedded system 102 through authorization access. The embedded system 102 transmits authorization access to each receiver, granting them permission to read the next available frame from the linked list 202. This ensures coordinated access where receivers read authorized frames in sequence. Once a receiver device finishes reading a frame, its access authorization is released, i.e., the frame is not accessible to the receiver device anymore.

As mentioned above, the receivers read frames from the right end of the linked list 202 in contrast to the embedded system 102 mounting new frames on the left end. This opposite-directional access creates a natural flow where receivers obtain the oldest frames for processing while the provider appends new frames after those receivers have already accessed earlier frames. Such configuration also allows the devices to access the frames 204 asynchronously at their respective frame rates.

Following are some exemplary configurations regarding the reading rate of the receivers and the mounting rate of the embedded system 102. However, they are merely illustrative and not limiting:
1. The reading rate is the same as the mounting rate. In other words, the receiver reads one mounted frame whenever the provider mounts one frame on the linked list.
2. The reading rate is half the mounting rate, but each time, two frames are read from the linked list.
3. The reading rate is adaptively changing based on the count of unread frames on the linked list 202. In other words, when the receiver detects more unread frames accumulating on the linked list 202, it increases its reading rate or the count of frames it reads each time, or vice versa.

In some examples, each frame 204 mounted on the linked list 202 may contain one or more status indicators 206. Specifically, each receiver may have a respective status indicator 206 on each frame 204 indicating whether the receiver has read, is currently accessing, or has released that frame. The embedded system 102 may use the status indicator 206 to identify reusable frames which no receivers are currently accessing and can be overwritten with new frame data. In some examples, when a frame is removed, the new frame is still mounted on the first end of the linked list 202 rather than on the empty slot of the removed frame. By doing so, the time sequence of the frames 204 can be maintained.

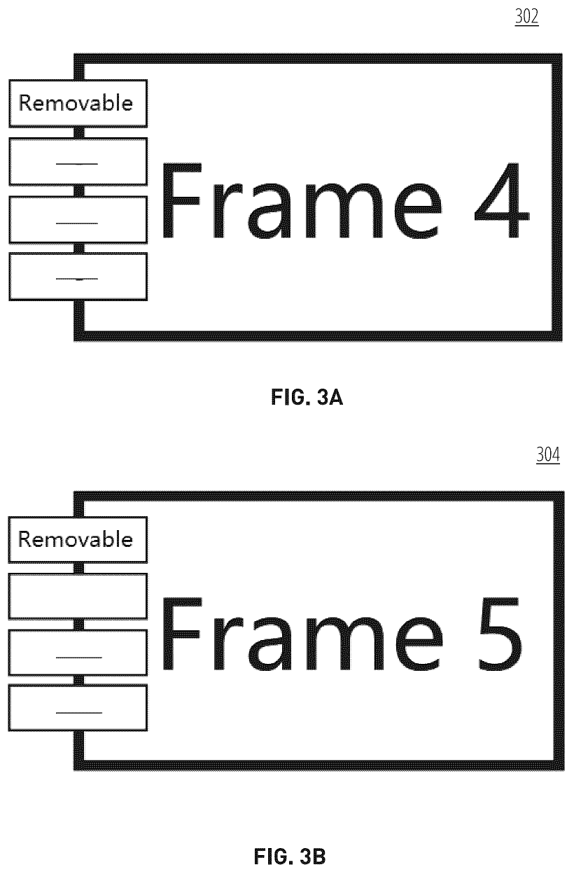

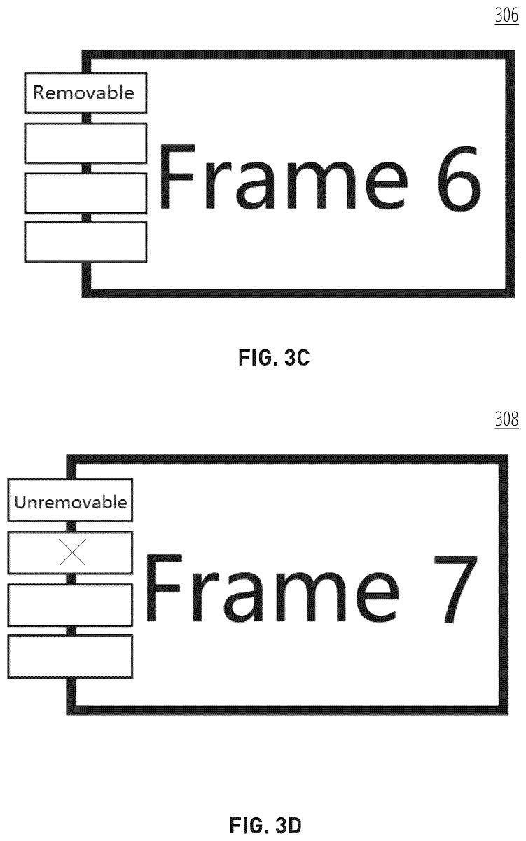

FIGS. 3A-3D are schematic diagrams illustrating exemplary frames (e.g., frame 4 302, frame 5 304, frame 6 306, frame 7 308) with status indicators associated with receivers, in accordance with some example embodiments. Merely by example, each frame has three status indicators reflecting their current status associated with three receivers and a status indicator reflecting whether the each frame is removable. A horizontal bar “−” indicates that the corresponding receiver has read and released the frame, an empty space “ ” indicates that the corresponding receiver has not read the frame, and a cross “x” indicates that the corresponding receiver is currently reading the frame. In some examples, each frame may further include a status indicator that indicates which target group it belongs to.

As shown in FIG. 3A, frame 4 302 has three “−” status indicators, indicating that all three receivers have read and released the frame 4 302. Based on the status indicators, frame 4 302 may be determined to belong to a first target group of frames as disclosed elsewhere in the present disclosure. Specifically, frame 4 302 is immediately removable when the available storage space of the memory drops below a threshold. In other words, frame 4 302 may be prioritized to be removed before frames in the second target group of frames (e.g., frame 5 304) and the third target group of frames (e.g., frame 6 306) are removed.

Referring to FIG. 3B, frame 5 304 has two “−” status indicators and one “ ” status indicator, denoting that receiver 1 and receiver 2 have read and released frame 5 304, while receiver 3 has not read frame 5 304. Based on the status indicators, frame 5 304 may be determined to belong to a second target group of frames as described elsewhere in the disclosure. Specifically, frame 5 304 is considered removable but would typically be removed only after frames in the first target group are exhausted (or removed) and the available storage space remains below the threshold.

Referring to FIG. 3C, frame 6 306 contains three “ ” status indicators next to each receiver. This means none of the receivers have read frame 6 306 yet. Based on the status indicators, frame 6 306 may be determined to belong to a third target group of frames as described elsewhere in the disclosure. Specifically, frame 6 306 is available to be removed only if necessary, such as when available storage space remains below the threshold after frames in both the first group and second group have already all been removed.

Referring to FIG. 3D, frame 7 308 has one “x” status indicator next to receiver 3, denoting it is currently being read. The frame 7 308 also has two “ ” indicators showing that receivers 1 and 2 have previously read and released this frame 308. However, as long as there is at least one “x” status indicator or at least one receiver is currently reading the frame, the frame cannot be removed. In some examples, the linked list (e.g., linked list 202) may have more slots than the count of receivers such that there would always be at least one frame that is not currently read by the receivers and can be removed. Such configuration ensures the normal operations of the present system.

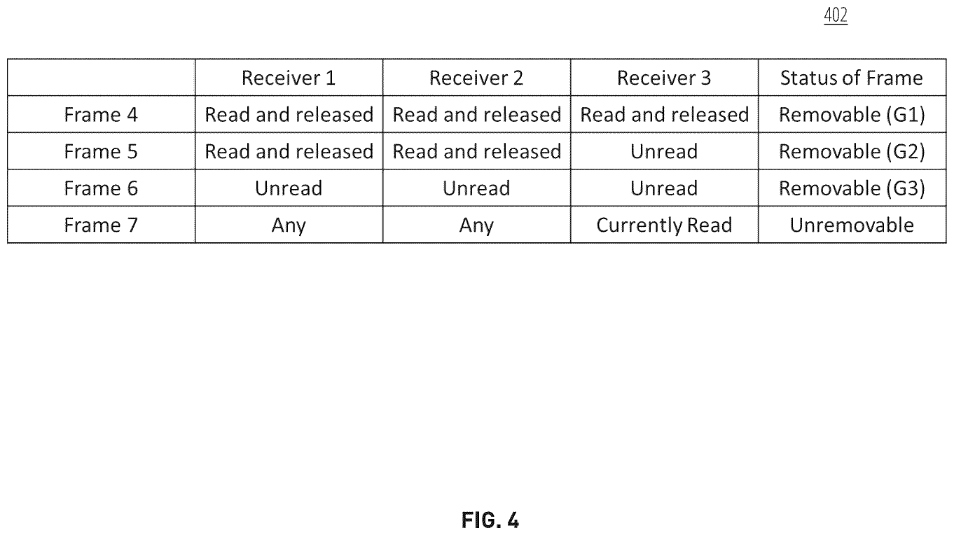

FIG. 4 is a table 402 illustrating statuses of mounted frames 4-7 based on status indicators associated with receivers 1-3, in accordance with some example embodiments.

Specifically, the table 402 summarizes the status indicators and target group classifications described in FIGS. 3A-3D for frames 4, 5, 6, and 7. As shown in FIGS. 3A-3D and table 402, frame 4 has been fully read and released by receivers 1-3 and is determined to belong to a first target group. Frame 5 was read/released by some receivers and is determined to belong to a second target group. Frame 6 was unread by receivers 1-3 and is determined to belong to a third target group. Frame 7 is presently read by receiver 3 and cannot be removed.

When the available storage space of the memory drops below a threshold, the frames may be removed in a particular order based on their target group classifications. Specifically, frames in the first target group (e.g., frame 4) would be prioritized and removed first. If storage space remains below the threshold after removing frames in the first target group, frames in the second target group (e.g., frame 5) would then be removed.

Finally, frames in the third target group frames (e.g., frame 6) would be removed, if necessary, only after frames in both the first and second target group have all been removed. In the same group, older frames are removed earlier than the newer frames. These ordered removal operations ensure minimal impact on the receivers. In some examples, the threshold can be a predetermined data size or a proportion of the memory, e.g., 1 KB, 5 KB, 10 KB, 50 KB, 100 KB, 0% of memory, 10% of memory, 20% of memory, 30% of memory, 50% of memory, etc. Alternatively, the threshold can be a predetermined proportion of empty slots on the linked list, e.g., 1%, 2%, 5%, 10%, etc.

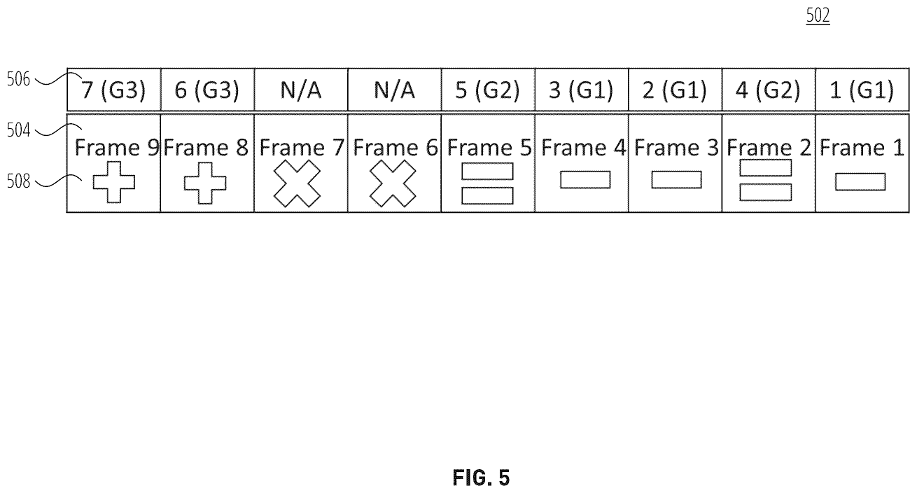

FIG. 5 is a schematic diagram illustrating an exemplary linked list 502 including multiple frames 504 with status indicators 508 and removing order 506, in accordance with some example embodiments. Merely by way of example, a cross “X” indicates that the frame is unremovable, a minus “−” indicates that the frame is removable and belongs to the first target group, an equal “=” indicates that the frame is removable and belongs to the second target group, and a plus “+” indicates that the frame is removable and belongs to the third target group.

As shown in FIG. 5, frames 1, 3, and 4 belong to the first target group. Frames 2 and 5 belong to the second target group. Frames 8 and 9 belong to the third target group. Frames 6 and 7 are unremovable.

When the available storage space of memory drops below a threshold, the frames are removed based on their target group classification. First, frames belonging to the first target group are removed, starting from the oldest frame mounted on the linked list. Since frame 1 is mounted earliest among the first target group frames, frame 1 would be removed first. Next, the other frames 3 and 4 in the first target group would be removed.

If, after removing all the frames in the first target group, the memory space still remains below the threshold, frames in the second target group would then be removed. Specifically, the older frame 2 would be removed first, followed by the newer frame 5.

Finally, if necessary, frames 8 and 9 in the third target group would be removed if the memory space still remains below the threshold after frames in both the first and second target groups have already been removed.

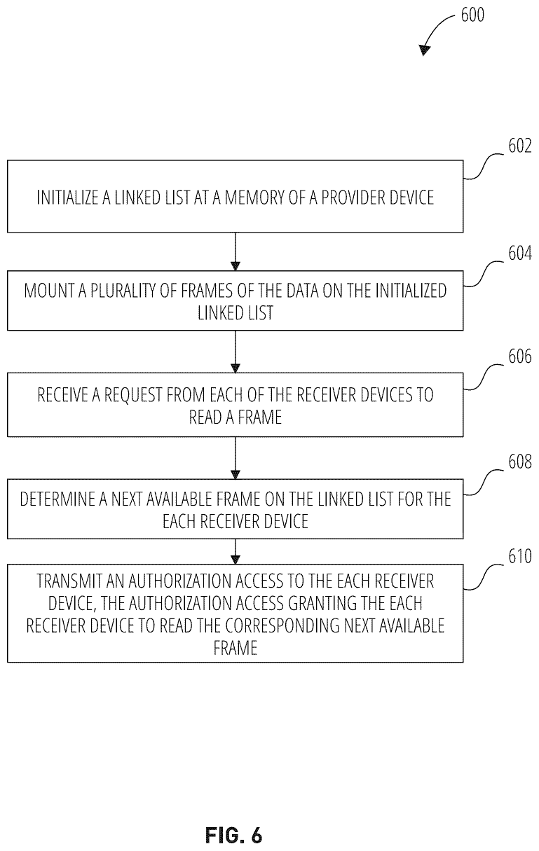

FIG. 6 is a flowchart illustrating operations of the provider device (e.g., provider device 102) for transmitting data to multiple receiver devices (e.g., external storage 106, external device 108, display 104) using a linked list (e.g., linked list 202), in accordance with some example embodiments. The method 600 may be embodied in computer-readable instructions for execution by one or more processors such that operations of the method 600 may be performed in part or in whole by the functional components of the provider device; accordingly, the method 600 is described below by way of example with reference thereto. However, it shall be appreciated that at least some of the operations of the method 600 may be deployed on various other hardware configurations than the provider device. Also, the operations of the method 600 may be partially omitted, or performed in any order.

In operation 602, the provider device may initialize a linked list data structure in its memory. For example, the provider device may allocate a predetermined number of empty slots or nodes for mounting frames of data. Each slot represents a potential frame that can be filled with images or other data for sharing with receivers.

In operation 604, as the provider device generates or receives new frames of data, it may mount those frames onto the linked list by filling the empty slots. The provider device may always fill on a first end and the mounted frame may be pushed to a second end of the linked list, making the first end empty and ready to be filled. This creates a buffer of frames that receivers can asynchronously access.

In operation 606, the provider may receive a request from each of the receiver devices to read a frame. The request may include an index or identifier associated with the frame. Alternatively, the receiver device may let the provider determine what frame to share with them.

In operation 608, the provider may determine the next available frame on the linked list for the each receiver device. The next available frame can be determined based on the index or identifier contained in the request. Alternatively, the provider can determine an oldest unread frame on the linked list as the next available frame for the each receiver device. Different receiver devices may have the same or different next available frames.

In operation 610, the provider may transmit authorization access to the each receiver device. The authorization access may grant the each receiver device to read the corresponding next available frame. In some examples, the authorization access can grant the receiver device to read any frame on the linked list, and the receiver device may determine what frame to read on their own.

In some examples, the provider device may detect that a receiver begins reading a frame using the authorization access. The provider device may then update status indicators to label that frame as currently read by that receiver. Later, the provider device may detect that the receiver has finished reading the frame. The provider device may then update the status indicator to mark that the frame has been released from that receiver device. In some examples, the provider device may withdraw the authorization access granted to a receiver device when the frame is released from the receiver device.

FIG. 7 is a flowchart illustrating operations of the provider device (e.g., embedded system 102) for removing mounted frames to save storage space of its memory (e.g., memory 112), in accordance with some example embodiments. The method 700 may be embodied in computer-readable instructions for execution by one or more processors such that operations of the method 700 may be performed in part or in whole by the functional components of the provider device; accordingly, the method 700 is described below by way of example with reference thereto. However, it shall be appreciated that at least some of the operations of the method 700 may be deployed on various other hardware configurations than the provider device. Also, the operations of the method 700 may be partially omitted, or performed in any order.

In operation 702, the provider device may monitor the usage of its allocated memory for the linked list over time. The provider may detect that available storage space falls below a predetermined threshold. In some examples, the threshold can be a predetermined data size or a proportion of the memory, e.g., 1 KB, 5 KB, 10 KB, 50 KB, 100 KB, 0% of memory, 10% of memory, 20% of memory, 30% of memory, 50% of memory, etc. Alternatively, the threshold can be a predetermined proportion of empty slots on the linked list, e.g., 1%, 2%, 5%, 10%, etc.

In operation 704, the provider device may analyze status indicators for all mounted frames to identify a first target group of frames. Specifically, it may search for frames that have been fully released by all receivers—i.e., read and no longer needed by any devices. Since these frames are not in use, removing them from the linked list can recover memory without impacting receivers.

In operation 706, if there are no frames in the first target group (either because there were initially no frames in the first target group or because all the frames in the first target group have been removed), the provider device may next look for a second target group of frames that has been read and released by at least one receiver but are still unread by other receivers.

In operation 708, if there are no frames in the first target group and the second target group, the provider device may finally look for a third target group of frames that has not been read by any of the receivers. Removing such frames would cause slight packet loss for the receiver devices but wouldn't cause any big problems.

In operation 710, once the provider device has identified a target group in operations 704-708, it may designate the oldest frame in that group as a target frame. Choosing the oldest frame as a removal target may increase the likelihood that more receivers have already accessed the frame.

In operation 712, the provider device may then remove the designated target frame by detaching it from the linked list to recover its allocated storage space.

In operation 714, after removing the target frame, the provider device may check if the available storage space of the memory is still below the threshold. In response to a determination that the available storage space of the memory is still below the threshold, the method 700 proceeds back to operation 704 and remove additional frame(s) to further recover storage space; otherwise, the method 700 proceeds to operation 716.

In operation 716, the provider continues to mount new frames on the linked list. The provider may mount the new frames on one side of the linked list rather than the empty slot recovered by removing the target frame so the frames on the linked list remain in a time order.

In some examples, operations 704-708 may be combined, modified, or omitted, and the classifications of the target group of frames can be modified. Below are some exemplary modifications, however, they are not limiting:
1. Operations 706 and 708 are combined, and frames that previously belong to the second target group and the third target group are removed in the same group based on their mounting time.
2. Operations 704-708 are combined, and any frames that are not currently read by the receivers are removed in the same group based on their mounting time.

In some examples, the operation 710 can also be modified. The target frame can be determined among each target group based on criteria other than the mounting time. For example, for frames in the second target group, a frame that has been read and released by more receivers may be determined to be the target frame and removed first.

In some examples, when the receiver device has been reading a frame for more than a time threshold (e.g., 100 ms, 500 ms, 1 s, 2 s, 5 s, 10 s, etc.), the provider device can determine that the receiver device has faced a connection problem or forgotten to release the frame. Since the frame cannot be recycled when the receiver is still reading it, storage space corresponding to the frame would be wasted. Accordingly, the provider device may actively monitor the time that every receiver device has been reading their frames. When the provider device determines that a receiver device has currently been reading a frame for more than the time threshold, it may actively release the frame from the receiver device by stopping granting the receiver device access to the frame.

In some examples, reading or accessing a frame mounted on the linked list may include “flushing” the frame to the main bus of the receivers, which forcibly synchronizes or updates the memory of the receivers. Such flushing operation usually has almost no lags.

### EXAMPLES

1. A method at a provider device for sharing data from the provider device to one or more receiver devices, the method comprising:
   initializing a linked list at a memory of the provider device;
   mounting a plurality of frames of the data on the initialized linked list;
   receiving a request from each of the receiver devices to read a frame;
   determining a next available frame on the linked list for the each receiver device; and
   transmitting authorization access to the each receiver device, the authorization access granting the each receiver device to read a corresponding next available frame.
2. The method of example 1, wherein:
   the plurality of frames of the data are mounted on a first end of the linked list; and
   the one or more receiver devices are allowed to read the next available frame from a second end of the linked list,
   wherein, among the plurality of frames, a new frame mounted to the first end of the linked list pushes an old frame towards the second end.
3. The method of examples 1 or 2, further comprising:
   determining that an available storage space of the memory of the provider device is less than a threshold; and
   in response to determining that the space of the memory of the provider device is less than a threshold,
      iteratively performing space saving operations until the available storage space of the memory is more than or equal to the threshold, the operations comprising:
         determining a target frame among the plurality of frames, the target frame not being currently read by the one or more receiver devices; and
         removing the target frame from the linked list.
4. The method of example 3, wherein the determining of the target frame among the plurality of frames comprises:
   determining a first target group of frames among the plurality of frames, the first target group of frames being read and released by all of the one or more receiver devices; and
   designating an oldest frame in the first target group of frames as the target frame, the oldest frame being mounted on the linked list earlier than other frames in the first target group of frames.
5. The method of example 4, wherein the determining of the target frame among the plurality of frames further comprises:
   determining that there are no more frames in the first target group;
   determining a second target group of frames among the plurality of frames, the second target group of frames being read and released by at least one of the one or more receiver devices and not being currently read by any of the one or more receiver devices; and
   designating an oldest frame in the second target group of frames as the target frame, the oldest frame being mounted on the linked list earlier than other frames in the second target group of frames.
6. The method of example 5, wherein the determining of the target frame among the plurality of frames comprises:
   determining that there are no more frames in the second target group;
   determining a third target group of frames among the plurality of frames, the third target group of frames not being currently read by any of the one or more receiver devices; and
   designating an oldest frame in the third target group of frames as the target frame, the oldest frame being mounted on the linked list earlier than other frames in the third target group of frames.
7. The method of any of examples 1-6, further comprising:
   determining that a receiver device has currently been reading a frame of the plurality of frames for more than a time threshold; and
   releasing the frame from the receiver device by stopping granting the receiver device access to the frame.
8. The method of any of examples 1-7, wherein:
   the one or more receiver devices have different frame rates; and
   the provider device allows the one or more receiver devices to read the plurality of frames asynchronously at the different frame rates.
9. The method of any of examples 1-8, wherein:
   the initializing of the linked list includes preparing a plurality of empty slots in the linked list; and
   the mounting of the plurality of frames of the data on the initialized linked list includes filling the plurality of empty slots by the plurality of frames of the data.
10. The method of any of examples 1-9, further comprising:
   detecting that a receiver device of the one or more receiver devices begins to read the next available frame using the authorization access;
   labelling the frame with a status indicator indicating that the receiver device is currently reading the frame;
   detecting that the receiver device finishes reading the frame; and
   updating the status indicator to indicate that the frame is released from the receiver device.
11. A provider device comprising:
   a processor; and
   a memory storing instructions for sharing data from the provider device to one or more receiver devices that, when executed by the processor, configure the provider device to:
      initialize a linked list at the memory of the provider device;
      mount a plurality of frames of the data on the initialized linked list;
      receive a request from each of the one or more receiver devices to read a frame;
      determine a next available frame on the linked list for the each receiver device; and
      transmit authorization access to the each receiver device, the authorization access granting the each receiver device to read a corresponding next available frame.
12. The provider device of example 11, wherein:
   the plurality of frames of the data are mounted in a time order on a first end of the linked list; and
   the one or more receiver devices are allowed to read the next available frame from a second end of the linked list,
   wherein, among the plurality of frames, a new frame mounted to the first end of the linked list pushes an old frame towards the second end.
13. The provider device of examples 11 or 12, wherein the instructions further configure the provider device to:
   determine that an available storage space of the memory of the provider device is less than a threshold; and
   in response to determining that the space of the memory of the provider device is less than a threshold,
      iteratively perform space saving operations until the available storage space of the memory is more than or equal to the threshold, the operations comprising:
         determine a target frame among the plurality of frames, the target frame not being currently read by the one or more receiver devices; and
         remove the target frame from the linked list.
14. The provider device of example 13, wherein to determine the target frame among the plurality of frames, the instructions further configure the provider device to:
   determine a first target group of frames among the plurality of frames, the first target group of frames being read and released by all of the one or more receiver devices; and
   designate an oldest frame in the first target group of frames as the target frame, the oldest frame being mounted on the linked list earlier than other frames in the first target group of frames.
15. The provider device of example 14, wherein to determine the target frame among the plurality of frames, the instructions further configure the provider device to:
   determine that there are no more frames in the first target group;
   determine a second target group of frames among the plurality of frames, the second target group of frames being read and released by at least one of the one or more receiver devices and not being currently read by any of the one or more receiver devices; and
   designate an oldest frame in the second target group of frames as the target frame, the oldest frame being mounted on the linked list earlier than other frames in the second target group of frames.
16. The provider device of example 15, wherein to determine the target frame among the plurality of frames, the instructions further configure the provider device to:
   determine that there are no more frames in the second target group;
   determine a third target group of frames among the plurality of frames, the third target group of frames not being currently read by any of the one or more receiver devices; and
   designate an oldest frame in the third target group of frames as the target frame, the oldest frame being mounted on the linked list earlier than other frames in the third target group of frames.
17. The provider device of any of examples 11-16, wherein the instructions further configure the provider device to:
   determine that a receiver device has currently been reading a frame of the plurality of frames for more than a time threshold; and
   release the frame from the receiver device by stopping granting the receiver device access to the frame.
18. The provider device of any of examples 11-17, wherein:
   the one or more receiver devices have different frame rates; and
   the provider device allows the one or more receiver devices to read the plurality of frames asynchronously at the different frame rates.
19. The provider device of any of examples 11-18, wherein the instructions further configure the provider device to:
   detect that a receiver device of the one or more receiver devices begins to read the next available frame using the authorization access;
   label the frame with a status indicator indicating that the receiver device is currently reading the frame;
   detect that the receiver device finishes reading the frame; and
   update the status indicator to indicate that the frame is released from the receiver device.
20. A non-transitory computer-readable storage medium, the computer-readable storage medium including instructions that when executed by a provider device, cause the provider device to:
   initialize a linked list at a memory of the provider device;
   mount a plurality of frames of data on the initialized linked list;
   receive a request from each of the receiver devices to read a frame;
   determine a next available frame on the linked list for the each receiver device; and
   transmit authorization access to the each receiver device, the authorization access granting the each receiver device to read a corresponding next available frame.

### CONCLUSION

The present disclosure provides systems and methods for efficiently transmitting image data from a provider device to receiver devices. It enables direct data sharing without duplication by allowing receiver devices to access frames from a linked list in the provider device's memory. The provider device initializes the linked list with empty slots and mounts new image frames from one end, while the receiver devices read frames from the other end to get the latest sequential data. The system tracks frame access status and recycles mounted frames by removing old frames not currently in use when storage space of memory is low. The present disclosure potentially has at least the following advantages: 1. Reduces memory and bandwidth usage by eliminating unnecessary data copies and transfers. Frames are shared directly between the provider and receivers without duplication. 2. Improves efficiency of transmission. Receivers can read frames asynchronously at their own frame rates. 3. Saves storage space by recycling unused frames without interfering with the regular operations of receiver devices. Only frames not currently being accessed are recycled.

What is claimed is:

1. A method at a provider device for sharing data from the provider device to one or more receiver devices, the method comprising:
initializing a linked list at a memory of the provider device;
mounting a plurality of frames of the data on the initialized linked list;
receiving a request from each of the receiver devices to read a frame;
determining a next available frame on the linked list for the each receiver device; and
transmitting authorization access to the each receiver device, the authorization access granting the each receiver device to read a corresponding next available frame.

2. The method of claim 1, wherein:
the plurality of frames of the data are mounted on a first end of the linked list; and
the one or more receiver devices are allowed to read the next available frame from a second end of the linked list,
wherein, among the plurality of frames, a new frame mounted to the first end of the linked list pushes an old frame towards the second end.

3. The method of claim 1, further comprising:
determining that an available storage space of the memory of the provider device is less than a threshold; and
in response to determining that the space of the memory of the provider device is less than a threshold,
iteratively performing space saving operations until the available storage space of the memory is more than or equal to the threshold, the operations comprising:
determining a target frame among the plurality of frames, the target frame not being currently read by the one or more receiver devices; and
removing the target frame from the linked list.

4. The method of claim 3, wherein the determining of the target frame among the plurality of frames comprises:
determining a first target group of frames among the plurality of frames, the first target group of frames being read and released by all of the one or more receiver devices; and
designating an oldest frame in the first target group of frames as the target frame, the oldest frame being mounted on the linked list earlier than other frames in the first target group of frames.

5. The method of claim 4, wherein the determining of the target frame among the plurality of frames further comprises:
determining that there are no more frames in the first target group;
determining a second target group of frames among the plurality of frames, the second target group of frames being read and released by at least one of the one or more receiver devices and not being currently read by any of the one or more receiver devices; and
designating an oldest frame in the second target group of frames as the target frame, the oldest frame being mounted on the linked list earlier than other frames in the second target group of frames.

6. The method of claim 5, wherein the determining of the target frame among the plurality of frames comprises:
determining that there are no more frames in the second target group;
determining a third target group of frames among the plurality of frames, the third target group of frames not being currently read by any of the one or more receiver devices; and
designating an oldest frame in the third target group of frames as the target frame, the oldest frame being mounted on the linked list earlier than other frames in the third target group of frames.

7. The method of claim 1, further comprising:
determining that a receiver device has currently been reading a frame of the plurality of frames for more than a time threshold; and
releasing the frame from the receiver device by stopping granting the receiver device access to the frame.

8. The method of claim 1, wherein:
the one or more receiver devices have different frame rates; and
the provider device allows the one or more receiver devices to read the plurality of frames asynchronously at the different frame rates.

9. The method of claim 1, wherein:
the initializing of the linked list includes preparing a plurality of empty slots in the linked list; and
the mounting of the plurality of frames of the data on the initialized linked list includes filling the plurality of empty slots by the plurality of frames of the data.

10. The method of claim 1, further comprising:
detecting that a receiver device of the one or more receiver devices begins to read the next available frame using the authorization access;
labelling the frame with a status indicator indicating that the receiver device is currently reading the frame;
detecting that the receiver device finishes reading the frame; and
updating the status indicator to indicate that the frame is released from the receiver device.

11. A provider device comprising:
a processor; and
a memory storing instructions for sharing data from the provider device to one or more receiver devices that, when executed by the processor, configure the provider device to:
initialize a linked list at the memory of the provider device;
mount a plurality of frames of the data on the initialized linked list;
receive a request from each of the one or more receiver devices to read a frame;
determine a next available frame on the linked list for the each receiver device; and
transmit authorization access to the each receiver device, the authorization access granting the each receiver device to read a corresponding next available frame.

12. The provider device of claim 11, wherein:
the plurality of frames of the data are mounted in a time order on a first end of the linked list; and
the one or more receiver devices are allowed to read the next available frame from a second end of the linked list,
wherein, among the plurality of frames, a new frame mounted to the first end of the linked list pushes an old frame towards the second end.

13. The provider device of claim 11, wherein the instructions further configure the provider device to:
determine that an available storage space of the memory of the provider device is less than a threshold; and
in response to determining that the space of the memory of the provider device is less than a threshold,
iteratively perform space saving operations until the available storage space of the memory is more than or equal to the threshold, the operations comprising:
determine a target frame among the plurality of frames, the target frame not being currently read by the one or more receiver devices; and
remove the target frame from the linked list.

14. The provider device of claim 13, wherein to determine the target frame among the plurality of frames, the instructions further configure the provider device to:
determine a first target group of frames among the plurality of frames, the first target group of frames being read and released by all of the one or more receiver devices; and
designate an oldest frame in the first target group of frames as the target frame, the oldest frame being mounted on the linked list earlier than other frames in the first target group of frames.

15. The provider device of claim 14, wherein to determine the target frame among the plurality of frames, the instructions further configure the provider device to:
determine that there are no more frames in the first target group;
determine a second target group of frames among the plurality of frames, the second target group of frames being read and released by at least one of the one or more receiver devices and not being currently read by any of the one or more receiver devices; and
designate an oldest frame in the second target group of frames as the target frame, the oldest frame being mounted on the linked list earlier than other frames in the second target group of frames.

16. The provider device of claim 15, wherein to determine the target frame among the plurality of frames, the instructions further configure the provider device to:
determine that there are no more frames in the second target group;
determine a third target group of frames among the plurality of frames, the third target group of frames not being currently read by any of the one or more receiver devices; and
designate an oldest frame in the third target group of frames as the target frame, the oldest frame being mounted on the linked list earlier than other frames in the third target group of frames.

17. The provider device of claim 11, wherein the instructions further configure the provider device to:
determine that a receiver device has currently been reading a frame of the plurality of frames for more than a time threshold; and
release the frame from the receiver device by stopping granting the receiver device access to the frame.

18. The provider device of claim 11, wherein:
the one or more receiver devices have different frame rates; and
the provider device allows the one or more receiver devices to read the plurality of frames asynchronously at the different frame rates.

19. The provider device of claim 11, wherein the instructions further configure the provider device to:
detect that a receiver device of the one or more receiver devices begins to read the next available frame using the authorization access;
label the frame with a status indicator indicating that the receiver device is currently reading the frame;
detect that the receiver device finishes reading the frame; and
update the status indicator to indicate that the frame is released from the receiver device.

20. A non-transitory computer-readable storage medium, the computer-readable storage medium including instructions that when executed by a provider device, cause the provider device to:
initialize a linked list at a memory of the provider device;
mount a plurality of frames of data on the initialized linked list;
receive a request from each of the receiver devices to read a frame;
determine a next available frame on the linked list for the each receiver device; and
transmit authorization access to the each receiver device, the authorization access granting the each receiver device to read a corresponding next available frame.
